(19) United States
(12) Patent Application Publication
(10) Pub. No.: US 2026/0141348 A1
(43) Pub. Date: May 21, 2026

(54) COLLABORATIVE FLOW EDITING SYSTEM AND METHOD

(71) Applicant: GEMBA SOFTWARE SOLUTIONS INC., Saint John (CA)

(72) Inventors: Adrian PHINNEY, Toronto (CA); Andrew ALBERT, Saint John (CA); Yannick DUFILS, Moncton (CA)

(21) Appl. No.: 19/394,215

(22) Filed: Nov. 19, 2025

Related U.S. Application Data
(60) Provisional application No. 63/722,134, filed on Nov. 19, 2024.

(51) Int. Cl. G06Q 10/101; G06F 16/901

(52) U.S. Cl. CPC G06Q 10/101; G06F 16/9024

(57) ABSTRACT

Systems and methods for collaborative editing of a procedure-flow graph. A repository stores a live graph of nodes and directed edges. A server implements:
(i) a change-request engine creating a draft copy associated with a baseline identifier; (ii) a graph engine computing differences, detecting baseline mismatches, and performing a rebase that aligns draft nodes and edges to the current live graph using persistent identifiers and, when absent, similarity heuristics, while preserving topological order, validating mandatory navigation links, and merging non-conflicting edits; and (iii) a conflict-resolution engine presenting side-by-side views, enabling flow-scoped discard, and executing a placeholder-copy workflow that replays local edits onto a subgraph initialized from the live graph. An approval module publishes approved drafts and flags other drafts as out-of-date. Client devices render side-by-side views and accept inputs to initiate rebase, resolve conflicts, and submit drafts. Embodiments provide changes panels, draft navigation, and baseline provenance.

### PRIORITY STATEMENT

This non-provisional patent application claims priority based upon the prior U.S. provisional patent application entitled “COLLABORATIVE FLOW EDITING SYSTEM AND METHOD”, application number 63/722,134, filed Nov. 19, 2024, in the name of GEMBA SOFTWARE SOLUTIONS INC., which is hereby incorporated herein in its entirety.

### TECHNICAL FIELD

The present invention relates to a collaborative flow editing system and method.

### BACKGROUND

Organizations typically introduce standardized operating procedures in order to improve efficiency in operations and control quality. This is especially necessary in large organizations where the size of the operation typically prohibits close supervision of more than a portion of the tasks by any one trusted individual, or in organizations having multiple offices at different locations, many or all of which may be involved at one point in a given procedure.

Traditionally, such standardized procedures are documented in an organization handbook or the like, are in a written form and may include some descriptive tools such as flow charts or the like to aid the members of the organization in better understanding when a certain task should be performed, by whom and it's interrelationship with other tasks.

In order to improve the ease and efficiency of developing and enforcing standardized operating procedures, a number of tools have been developed. These tools are typically implemented in a networked environment to better leverage collaboration between those developing the operating procedures, simplify roll out and simplify the production of usage reports for audits and governance amongst other reasons.

These tools typically include a graphical user interface displaying a flow chart or the like. One such tool is described in U.S. Pat. No. 10,552,797 for a Procedure Flow Administration System and Method which is incorporated herein by reference in its entirety.

One drawback of these tools, however, is that it is difficult to modify the procedure in a collaborative environment where multiple editors may be introducing changes into a procedure flow, all or only some of which may be eventually form part of a live version of the tool. In particular, in these tools an editing user would first make a copy of the current active (live) version of the procedure flow which would be subsequently edited. The editing user would submit changes for changes for approval at which point they would no longer be able to make any changes until the draft was approved. Additionally, no provision was made to allow an editing user view additional changes which might be introduced by another editing user in the submitted draft version.

### SUMMARY

Disclosed are systems, methods, and computer-readable media for collaborative editing of a procedure-flow graph. In one aspect, a collaborative procedure-flow editing system includes: a repository storing a live procedure-flow graph comprising nodes and directed edges, each node representing a step in a procedure and each edge representing a navigation link between steps; a server comprising a processor and memory storing instructions; and client devices communicatively coupled via a network. The instructions implement: (a) a change-request engine configured to create, for an editing user, a draft procedure-flow graph as an editable copy of the live procedure-flow graph and to associate the draft with a baseline identifier of the live procedure-flow graph, the draft procedure-flow graph comprising a plurality of graph nodes and a plurality of graph edges; (b) a graph engine configured to (i) compute differences between the draft procedure-flow graph and the live procedure-flow graph, (ii) detect a baseline mismatch when a baseline identifier of the draft procedure-flow graph differs from a current identifier of the live procedure-flow graph, and (iii) in response to the baseline mismatch, perform a rebase operation that aligns the graph nodes and the graph edges of the draft procedure-flow graph to corresponding graph nodes and graph edges of the current live procedure-flow graph and merges non-conflicting edits from the draft while retaining those edits in the rebased draft, and (iv) detect conflicts under predetermined conflict rules including at least one of: concurrent edits to a same node attribute, deletion of a node or edge in one graph while modified in the other, and reassignment of an edge endpoint altered by both graphs; (c) a conflict-resolution engine configured to, upon detection of a conflict, (i) present a side-by-side visualization of the current live procedure-flow graph and the conflicting draft procedure-flow graph with highlighted differences, (ii) enable flow-scoped discard that discards edits to a portion of the draft without discarding other edits to one or more other portions, and (iii) enable a placeholder-copy workflow that copies local conflicting edits into a temporary placeholder graph, discards the conflicting portion of the graph, and reapplies the discarded edits from the placeholder graph onto a corresponding subgraph of the current live procedure-flow graph; and (d) an approval module configured to publish an approved draft by replacing the live procedure-flow graph in the repository and to flag other drafts associated with a prior baseline identifier as out-of-date. Client devices are configured to (i) render, for an editing user, a side-by-side view of the live procedure-flow graph and the draft procedure-flow graph with visual highlighting of graph-node-level and graph-edge-level edits; and (ii) receive user inputs to initiate the rebase operation, resolve conflicts using the flow-scoped discard and placeholder-copy workflows, and submit the draft for approval.

In some embodiments, each of the plurality of graph nodes includes a persistent identifier and a step type selected from Action, Decision, Data, and Backstory, and the graph engine aligns graph nodes using the persistent identifier and, when absent, using a similarity heuristic based on at least the step type, label text, and adjacency, the similarity heuristic comprising at least one of: hashing node content, attribute-vector comparison, and neighborhood overlap scoring. The graph engine represents edits as operations selected from: add-node, remove-node, modify-node-attribute, add-edge, remove-edge, and retarget-edge, and merges the operations against the current live procedure-flow graph during the rebase operation. The rebase operation preserves a topological ordering and validates that mandatory navigation links remain connected post-merge, raising a conflict when a validation check fails. The predetermined conflict rules are applied deterministically such that identical inputs produce identical merged graphs and conflict sets. The conflict-resolution engine supports iterative resolution across multiple conflicting subgraphs, persisting resolved portions while other conflicts remain outstanding.

In certain embodiments, the client devices provide a changes panel listing edits by operation type and affected node identifiers, each item navigable to a synchronized side-by-side visualization region; upon selection of an item, the side-by-side view is focused on the affected subgraph. The approval module, upon publishing an approved draft, transmits out-of-date notifications to client devices holding drafts with mismatched baselines and provides a one-click “merge from live” control to trigger the rebase operation; the notifications can comprise serialized deltas of node-and edge-level changes that update local baselines without transmitting full graph states. When performing the flow-scoped discard, only edits to a selected flow within a multi-flow change request are discarded, leaving edits to other flows intact. The placeholder-copy workflow can serialize local edits into a patch artifact, discard the conflicted portion from the draft, reinitialize the portion from the current live procedure-flow graph, and reapply the patch artifact, thereby surfacing any residual conflicts. Role-based access controls can define contributor, approver, and viewer roles with corresponding capabilities, and side-by-side visualization and rebase controls can be disabled for viewers. Client devices can provide a draft navigation mode that executes navigation across the draft procedure-flow graph to validate link integrity and expected branching behavior prior to approval. The graph engine can maintain a baseline provenance record for each draft including the baseline identifier, creation timestamp, and a list of merged live updates applied via rebase, and in some embodiments a parent commit identifier and a rebase lineage.

In another aspect, a computer-implemented method includes: storing, in a repository, a live procedure-flow graph comprising graph nodes and graph edges; creating, for an editing user, a draft procedure-flow graph as a copy of the live procedure-flow graph and associating the draft with a baseline identifier of the live procedure-flow graph; rendering, on a client device, a side-by-side view of the live procedure-flow graph and the draft procedure-flow graph with highlighted edits; detecting that the baseline identifier of the draft does not match a current identifier of the live procedure-flow graph; in response, performing a rebase operation comprising aligning corresponding graph nodes and corresponding graph edges of the draft procedure-flow graph to the graph nodes and the graph edges of the current live procedure-flow graph and merging non-conflicting edits from the draft into a rebased draft while retaining the edits; detecting conflicts based on predetermined conflict rules including at least concurrent modification of a same node attribute and deletion-versus-modification of a same graph node or a same graph edge; presenting a conflict-resolution interface including (i) flow-scoped discard of edits and (ii) a placeholder-copy workflow that copies local edits into a temporary placeholder, discards a conflicting portion of the draft procedure-flow graph, initializes a subgraph from the current live procedure-flow graph, and reapplies the local edits from the placeholder thereto; publishing, upon approval, the draft procedure-flow graph as the live procedure-flow graph and flagging other drafts with mismatched baselines as out-of-date; listing edit operations in a changes panel and, upon selection of an item, focusing the side-by-side view on the affected subgraph; validating the rebased draft for link integrity and mandatory-step connectivity and, upon validation failure, surfacing a conflict requiring user action; recording, for each draft, a baseline provenance including at least the baseline identifier and a log of applied rebases; and enforcing role-based permissions defining contributor, approver, and viewer roles with corresponding capabilities. In a further aspect, a non-transitory computer-readable medium stores instructions that, when executed by one or more processors, cause performance of any of the foregoing method operations.

### BRIEF DESCRIPTION OF THE DRAWINGS

FIG. 1 provides a schematic diagram of a collaborative flow editing system in accordance with an illustrative embodiment of the present invention;

FIG. 2 provides a flow viewer screen of a flow administration system in accordance with an illustrative embodiment of the present invention;

FIG. 3A provides a screen listing pending change requests in a flow administration system in accordance with an illustrative embodiment of the present invention;

FIG. 3B provides a change request screen visualising a flow in a flow administration system in accordance with an illustrative embodiment of the present invention;

FIG. 3C provides a detailed view of a screen displaying changes in a flow administration system in accordance with an illustrative embodiment of the present invention;

FIG. 3D provides a change request overview screen in a flow administration system in accordance with an illustrative embodiment of the present invention;

FIG. 3E provides a change request overview screen detailing the comment field in a flow administration system in accordance with an illustrative embodiment of the present invention;

FIG. 3F provides a change request screen detailing submission for approval in a flow administration system in accordance with an illustrative embodiment of the present invention;

FIG. 3G provides a change request approval screen in a flow administration system in accordance with an illustrative embodiment of the present invention;

FIG. 3H provides a change request screen showing live and edited flow versions side by side in a flow administration system in accordance with an illustrative embodiment of the present invention;

FIG. 3I provides a first conflict screen in a flow administration system in accordance with an illustrative embodiment of the present invention;

FIG. 3J provides a second conflict screen in a flow administration system in accordance with an illustrative embodiment of the present invention; and

FIG. 3K provides a conflict screen showing live and conflicting versions of a flow in a flow administration system in accordance with an illustrative embodiment of the present invention.

### DETAILED DESCRIPTION OF THE ILLUSTRATIVE EMBODIMENTS

The disclosure relates to computer-implemented processing of graph-structured data in distributed collaborative systems. More particularly, it concerns deterministic rebasing, diffing, and merging of graph-structured drafts edited asynchronously by multiple clients, with automatic validation of graph constraints and network-based synchronization.

Maintaining consistency across multiple diverging, graph-structured drafts in a collaborative, asynchronous editing environment is a computing problem. Human operators cannot efficiently align large directed graphs or compute graph diffs and merges under topological and reachability constraints, and prior systems relying on serial locking or manual reconciliation do not scale. Concurrent live updates cause baseline divergence that cannot be reconciled reliably without algorithmic comparison. The disclosed system addresses these issues using computer-implemented graph algorithms that are not reasonably performable as mental steps.

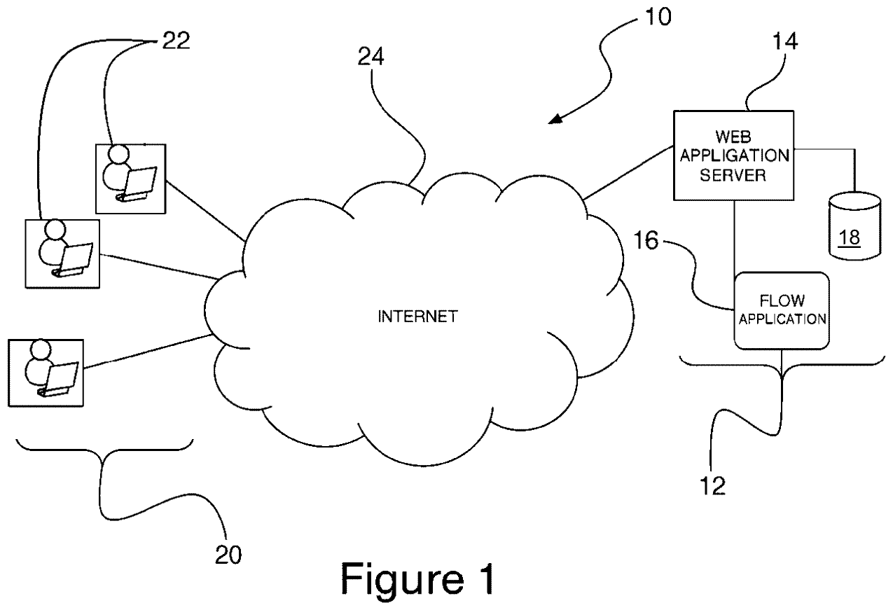

Referring now to FIG. 1, a collaborative flow editing system 10 includes a server portion 12 comprising one or more processors and memory (e.g., non-transitory computer-readable media) storing instructions executable to provide one or more web application servers 14 on which one or more flow applications 16 are executed. Each server 14 can access a data repository 18 (e.g., an SQL database) that persists graph data and provenance. A user portion 20 of the system 10 comprises a plurality of client devices 22 which access the one or more web application server(s) 14 typically via a broadband network 24 such as the Internet. Each client device 22 comprises a web browser which illustratively can receive, compile and display webpages comprising JavaScript, HTML and style sheets (CSS), all not shown, received from the web application server(s) 14. The data repository 18 stores a live procedure-flow graph comprising nodes and directed edges, each node representing a step in a procedure and each edge representing a navigation link between steps. In some embodiments the repository 18 stores the graph as internal computer data structures including adjacency lists and node-attribute arrays; drafts and live versions may be associated with version identifiers and baseline provenance metadata. The server portion 12 comprises one or more processors and a memory storing instructions that implement a change-request engine, a graph engine (also referred to herein as a graph diff-and-merge engine), a conflict-resolution engine, and an approval module, the change-request engine being configured to create, for an editing user, a draft procedure-flow graph as an editable copy of the live procedure-flow graph and to associate the draft procedure-flow graph with a baseline identifier of the live procedure-flow graph, the draft procedure-flow graph comprising a plurality of graph nodes and a plurality of graph edges. The graph engine is configured to: (i) compute differences between the draft procedure-flow graph and the live procedure-flow graph; (ii) detect a baseline mismatch when a baseline identifier of the draft procedure-flow graph differs from a current identifier of the live procedure-flow graph; and (iii) in response, perform a rebase operation that aligns graph nodes and graph edges using persistent identifiers and, when absent, similarity heuristics; preserves a topological ordering; validates mandatory navigation links and reachability constraints; replays structured edit operations in a deterministic topological sequence; and merges non-conflicting edits from the draft while retaining those edits in a rebased draft. The graph engine is further configured to detect conflicts under predetermined conflict rules including at least one of concurrent edits to a same node attribute, deletion of a node or an edge in one graph while modified in the other, and reassignment of an edge endpoint altered by both graphs. The predetermined conflict rules are applied deterministically such that identical inputs produce identical merged graphs and conflict sets. The conflict-resolution engine is configured to, upon detection of a conflict, present a side-by-side visualization of the current live procedure-flow graph and a conflicting draft procedure-flow graph with highlighted differences, enable flow-scoped discard that discards edits to a portion of the draft procedure-flow graph without discarding other edits to one or more other portions, and enable a placeholder-copy workflow that copies local conflicting edits into a temporary placeholder graph, discards a conflicting portion of the graph, and reapplies the discarded edits from the temporary placeholder graph onto a corresponding subgraph of the current live procedure-flow graph. The approval module is configured to publish an approved draft by replacing the live procedure-flow graph in the data repository 18 and to flag other drafts associated with a prior baseline identifier as out-of-date. Each client device 22 is configured to render, for an editing user, a side-by-side view of the live procedure-flow graph and the draft procedure-flow graph with visual highlighting of graph-node-level and graph-edge-level edits, and to receive user inputs to initiate the rebase operation, resolve conflicts using the flow-scoped discard and placeholder-copy workflows, and submit the draft for approval.

Each node includes a persistent identifier (PID) and a step type selected from Action, Decision, Data, and Backstory. During rebase, nodes are aligned using PIDs and, when a PID is absent or ambiguous, using a similarity heuristic based on at least the step type, label text, and neighboring topology, subject to preservation of a topological order. Edits may be represented as operations selected from add-node, remove-node, modify-node-attribute, add-edge, remove-edge, and retarget-edge, and the operations may be merged against the current live procedure-flow graph during the rebase operation. The rebase operation may preserve a topological ordering and may validate that mandatory navigation links remain connected post-merge, a conflict being raised when a validation check fails. Edits are replayed in a deterministic topological sequence such that identical inputs produce identical merged outputs and conflict sets. Validation enforces reachability and mandatory-link constraints. In some embodiments, the similarity heuristic includes content hashing, attribute-vector comparison, and neighborhood overlap scoring. The conflict-resolution engine may support iterative resolution across multiple conflicting subgraphs, persisting resolved portions while other conflicts remain outstanding. The client devices 22 may provide a changes panel listing edits by operation type and affected node identifiers, each item being navigable to a synchronized side-by-side visualization region. The approval module may, upon publishing an approved draft, transmit out-of-date notifications to client devices 22 holding drafts with mismatched baselines and may provide a one-click “merge from live” control to trigger the rebase operation. The rebase operation limits processing to changed subgraphs, reducing client recomputation and network traffic compared to reloading full graph copies, e.g., by transmitting or applying node-and edge-level deltas rather than entire graph states in some embodiments. When performing the flow-scoped discard, only edits to a selected flow within a multi-flow change request may be discarded, leaving edits to other flows intact. The placeholder-copy workflow may serialize local edits into a patch artifact, discard a conflicted portion from the draft, reinitialize the portion from the current live procedure-flow graph, and replay the patch in a deterministic topological order, thereby surfacing only residual conflicts that remain under the current topology. Role-based access controls may be enforced wherein contributors can create and edit drafts but cannot approve, approvers can approve and publish, and viewers can view only published drafts, and side-by-side visualization and rebase controls may be disabled for viewers. The client devices 22 may provide a draft navigation mode that executes navigation across the draft procedure-flow graph to validate link integrity and expected branching behavior prior to approval. A baseline provenance record may be maintained for each draft including the baseline identifier, a creation timestamp, and a list of merged live updates applied via rebase, and may further include, in some embodiments, a parent commit identifier and a rebase lineage. Each rebase and merge transforms computer memory storing the graph model by rewriting adjacency entries, node attribute values, and provenance records in storage. Client devices with out-of-date baselines are flagged and receive notifications; upon receipt, clients update local baselines to reflect the rebased state, effecting state transitions across networked devices.

A procedure-flow graph may be understood as a directed graph modeling a procedural sequence where nodes encode operational steps and edges encode allowed transitions between steps; for example, a Decision node may branch to alternative Action nodes according to labeled outcomes, and a Data node may precede an Action node that consumes or updates structured data. A baseline identifier may be understood as a version designator associated with a specific state of the live procedure-flow graph, for example a monotonically increasing revision number or a content-derived hash. A current identifier may be understood as the identifier of the live procedure-flow graph at the time of comparison, which updates whenever the live graph is modified. A rebase operation may be understood as a transformation that re-expresses draft edits relative to a newer baseline by aligning corresponding elements and replaying non-conflicting operations against the current live procedure-flow graph. The above operations act on internal computer data structures (adjacency lists, node-attribute arrays, and provenance logs) according to algorithmic rules and are not reasonably performable as mental steps for practical graph sizes or under concurrent editing. In some embodiments, the graph engine executes a rebase pipeline comprising: (i) compute a candidate correspondence between draft and live nodes using PIDs and similarity heuristics subject to topological constraints; (ii) validate mandatory links and reachability; (iii) compute a graph diff over node attributes and edges; (iv) replay structured edits in a topological order; (v) detect conflicts under predetermined rules including at least concurrent attribute mutation, deletion-versus-modification, or divergent edge retargeting; (vi) preserve non-conflicting edits and, for conflicts, instantiate placeholder copies from live subgraphs and emit a conflict set; and (vii) update baseline provenance and notify clients whose baselines are out-of-date. A conflict under the predetermined conflict rules may be understood as a condition where automatic merge semantics are undefined or non-deterministic, for example concurrent modification of a shared node label, deletion-versus-modification of the same node, or divergent retargeting of a shared edge endpoint. A flow-scoped discard may be understood as a selective rollback limited to a defined subgraph or flow within a broader change request. A placeholder-copy workflow may be understood as a sequence where local edits are preserved in a temporary representation, a conflicted working region is reset from a canonical source, and the preserved edits are reapplied to reveal remaining incompatibilities.

Still referring to FIG. 1, a user at a client device 22 may navigate via the broadband network 24 using a web browser of the client device 22 to an address served by the web application server(s) 14, whereupon a login page (not shown) may be rendered to the web browser as a webpage delivered by the web application server(s) 14 and generated by the flow applications 16. The login page may receive user credentials, user credentials being understood as authentication information associated with a user account, and, upon successful authentication, access may be granted to the server portion 12 and to the data repository 18 in accordance with role-based access controls.

Each user may be associated with role-based access controls including contributor, approver, and viewer roles, whereby a contributor may create and edit drafts but may be prohibited from approval, an approver may approve and publish, and a viewer may view only published drafts; side-by-side visualization and rebase controls may be disabled for viewers. Such role-based access controls may be used to selectively limit access to particular features of the collaborative flow editing system 10 and to the ability to create, amend, and approve edited procedure-flow graphs.

The procedure flow viewer 26 may be understood as a graphical interface that renders a diagrammatic representation of a procedure using elements corresponding to procedural steps and directed connections indicating an intended traversal order. A diagrammatic representation may be understood as an arrangement of symbolized steps positioned on a canvas with connecting flow arrows 40, where the symbols visually encode step types and the connecting flow arrows 40 encode navigation between steps. Tools for editing and approving edited procedure flows may be exposed within the procedure flow viewer 26 for particular users, where editing may include insertion, removal, and labeling of steps and adjustment of connecting flow arrows 40, and approval may include confirmation of a completed edit set for publication.

Action steps 30 are represented by a rectangular box illustratively colored blue and include descriptive text detailing the action to be taken by the user. Descriptive text for Action steps 30 may be understood as an instruction string that identifies an operation to perform, for example “Enter customer address” or “Start calibration sequence.” Action steps 30 may also be coded to indicate actions which are critical, and must be completed, illustratively by coloring the Action step 32 red. A critical Action step 32 may be understood as a mandatory operation whose completion is required before proceeding along one or more downstream flow arrows 40, for example a safety acknowledgment or a required authentication.

Decision steps 34 are represented by a diamond illustratively colored yellow and include descriptive text detailing the decision to be made by the user. Descriptive text for Decision steps 34 may be understood as a prompt expressing a choice or evaluation, for example “Payment approved?” or “Sensor within tolerance?” Flow arrows 40 leaving a Decision step 34 may include descriptive text that disambiguates branching outcomes, for example “Yes” and “No,” where the labeling clarifies which downstream step corresponds to each outcome.

Data steps 36 are represented by a rhomboid illustratively colored green and include descriptive text indicating information which should be collected by the user during the step as the information is typically necessary in order to complete one or more of the subsequent steps. Information for a Data step 36 may be understood as user-supplied data relevant to the procedure, for example an identifier, a measurement value, or a timestamp, where collection of the information enables correct execution of following Action steps 30 or correct evaluation at Decision steps 34.

Backstories 38 are represented by a rectangle illustratively colored purple and provide textual indications as to why data is being collected, tips, and the like. Backstories 38 may be understood as contextual annotations that supply rationale, guidance, or background material associated with neighboring steps, for example an explanation of regulatory requirements that motivate a Data step 36 or a short checklist that clarifies an Action step 30.

Free form text boxes and images can be included to provide additional information and graphics to provide illustrations of usage, additional tips on data entry and the like. A free form text box may be understood as a content element not bound to a specific step type that conveys explanatory or instructional text, for example a cautionary note or a summary paragraph. An image may be understood as a graphical asset embedded within the procedure flow 28 that conveys visual guidance, for example a schematic, a screenshot, or a photograph.

The various steps are interconnected by flow arrows 40, typically presented as a solid line arrow, which indicate the order in which the procedure flow is intended to proceed and may include descriptive text, for example to indicate the flow arrow to be followed on exiting a Decision step 34. A flow arrow 40 may be understood as a directed connector whose tail originates at a source step and whose head terminates at a target step, where inclusion of descriptive text on the flow arrow 40 clarifies transition conditions or entry criteria for the target step.

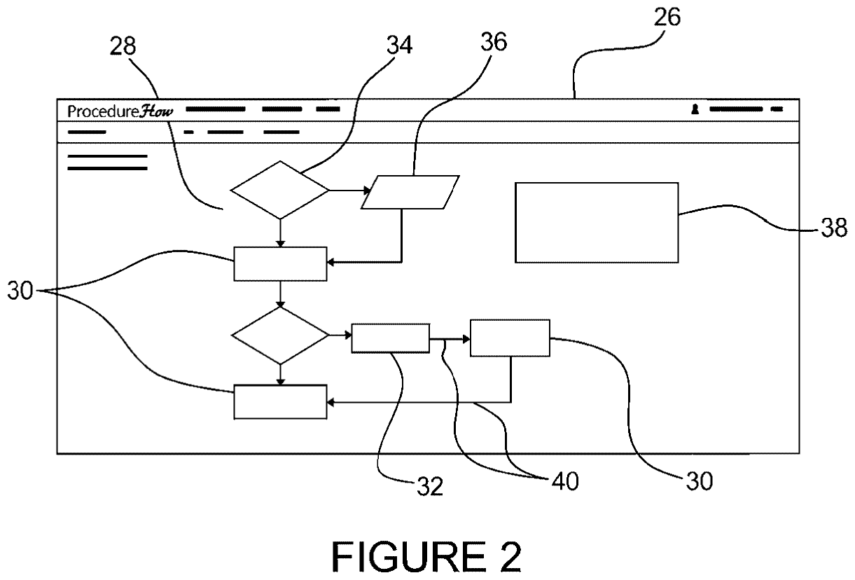

Still referring to FIG. 2, and as discussed above, in prior art tools an editing user would make a draft copy of a live version of the flow to edit and, once changes were submitted for approval, no further changes could be made until the draft was approved, and one editing user could not see what other editing users might be editing in respective draft versions. In order to address the foregoing, a change request has been introduced. A change request may be understood as a named work-in-progress container that includes, for an entry point, draft procedure-flow graphs for all flows 28 within a defined scope, each draft procedure-flow graph being created by a change-request engine as an editable copy of a live procedure-flow graph and associated with a baseline identifier of the live procedure-flow graph. Instead of editing a single active copy of a flow, an editing user may edit multiple copies, which results in multiple change requests, where separate draft procedure-flow graphs are maintained in the data repository 18 for each change request and are independently submitted for approval. Each change request is named to reflect the changes contained therein, a name of a change request being understood as a human-readable label indicative of an intended modification, for example “Add address validation branch” or “Update calibration sequence.” Each change request contains all the flows 28 in an entry point, an entry point being understood as a designated starting location within the procedure flow viewer 26 that defines the scope of included flows 28 and the associated flow arrows 40 for end-to-end validation. Each editing user may view, subject to role-based access controls, a list of change requests made by other editing users together with a status indicator of each change request, where status may include at least draft, submitted for approval, approved and published, and out-of-date. When editing the flows 28 in a change request, an editing user may test the navigation of all flows 28 and flow arrows 40 using a draft navigation mode on the client device 22 to execute traversal and validate link integrity and expected branching behavior prior to approval.

Still referring to FIG. 2, an approving user may assign a change request to a different editing user to take over edits originally commenced by a different editing user. Assignment of a change request may be understood as re-associating the change request with a designated editing user account stored in the data repository 18 while retaining a draft procedure-flow graph and a baseline identifier associated with the change request. Assignment may be initiated by an authenticated user having an approver role and may be constrained by role-based access controls such that only users with the approver role are enabled to perform assignment actions. Upon assignment, editing access for a previously assigned editing user may be revoked and editing access for a newly assigned editing user may be granted in accordance with the role-based access controls, while viewer access may remain limited to published drafts. The newly assigned editing user may, using a client device 22, render a side-by-side view of a live procedure-flow graph and the draft procedure-flow graph with visual highlighting of graph-node-level and graph-edge-level edits and may perform edits represented as operations selected from add-node, remove-node, modify-node-attribute, add-edge, remove-edge, and retarget-edge, and may submit the draft for approval using an approval module. Similarly, an approving user may assign a change request to the approving user, for example in order to make simple changes directly and avoid back-and-forth feedback.

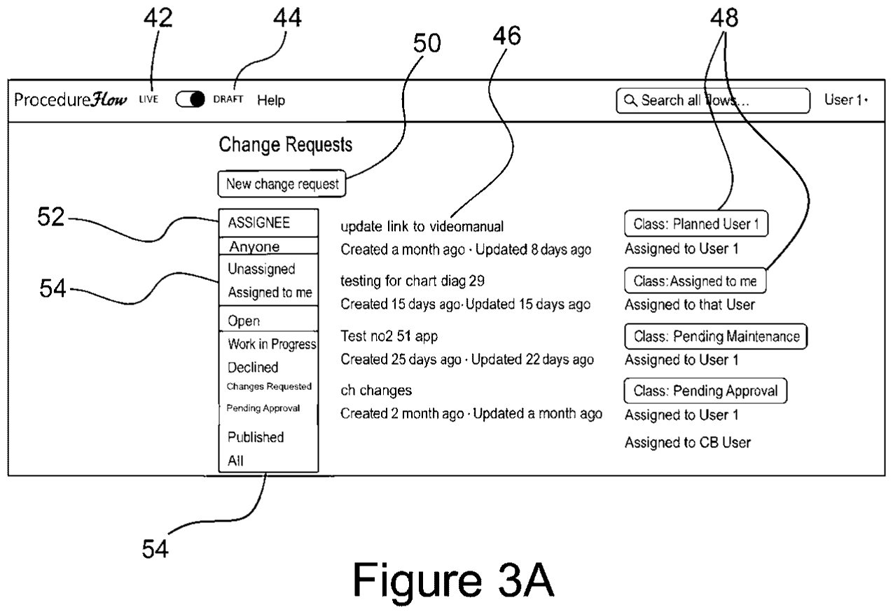

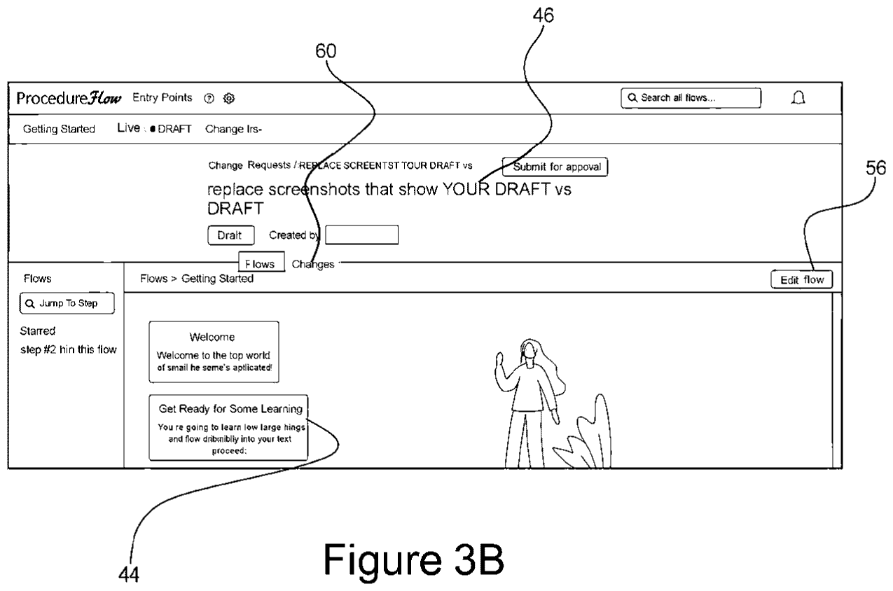

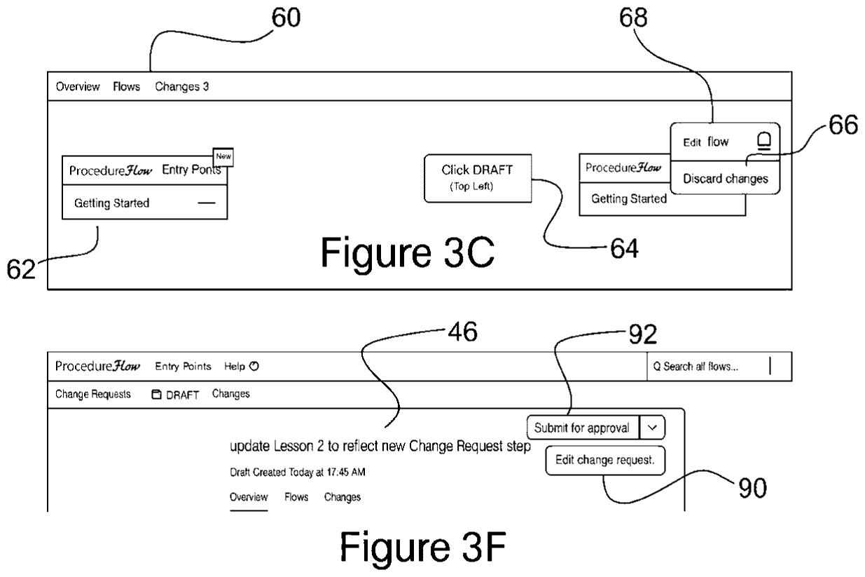

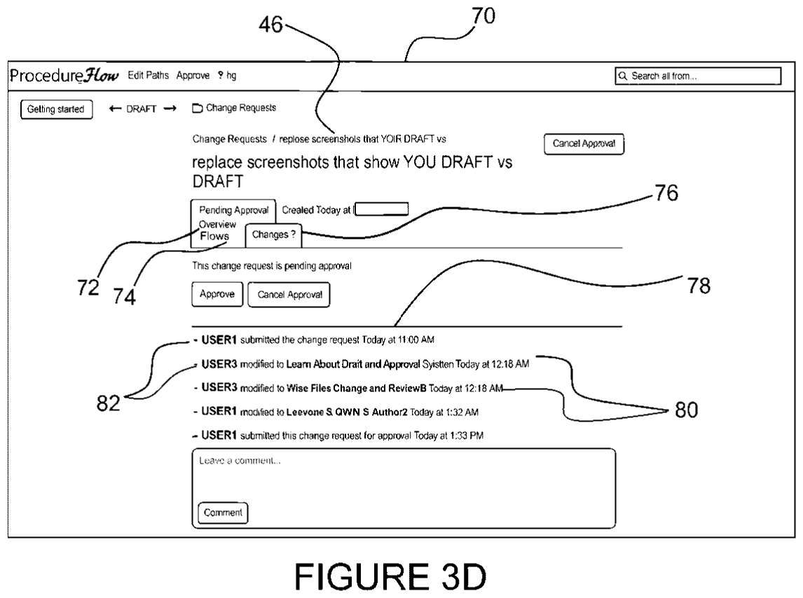

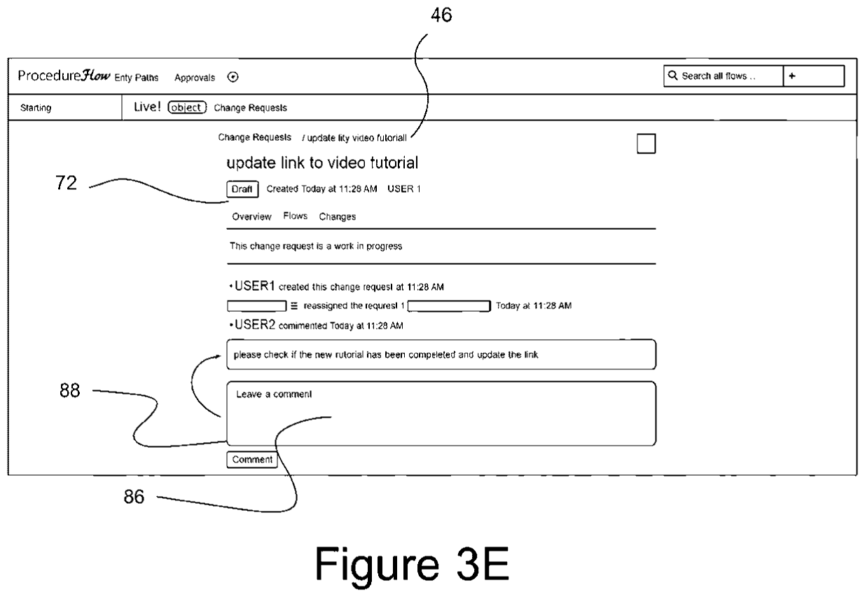

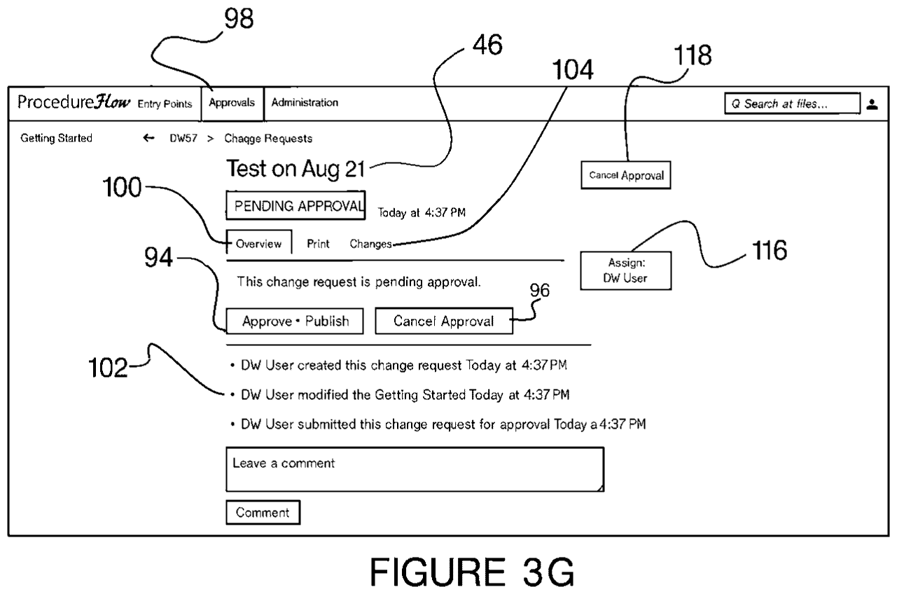

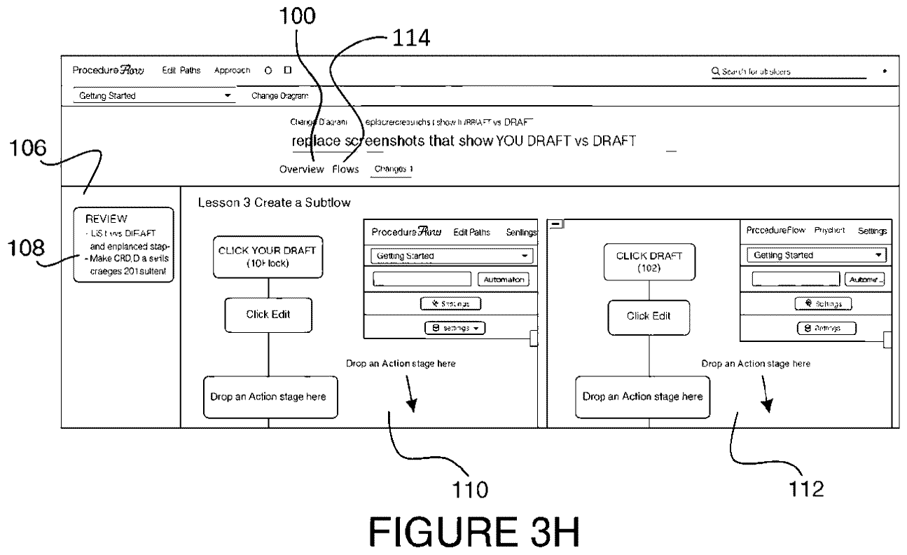

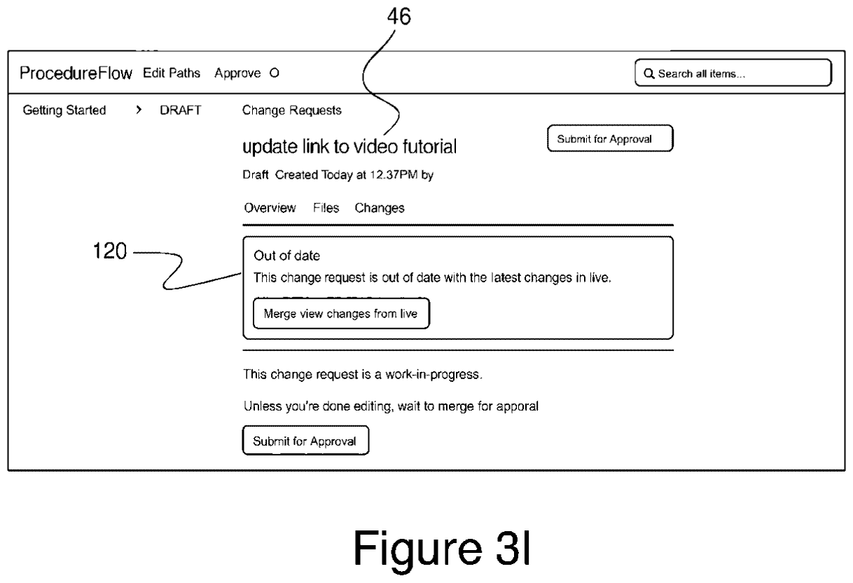

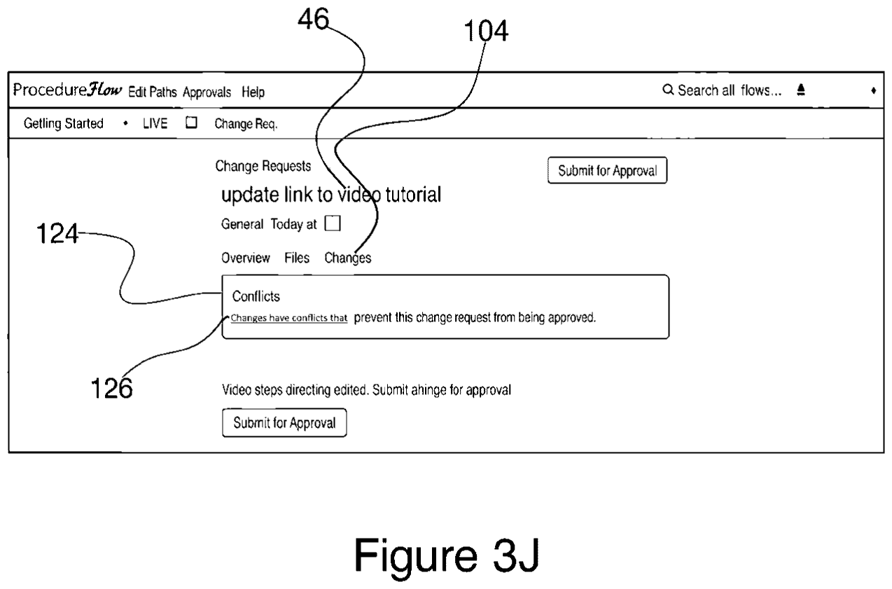

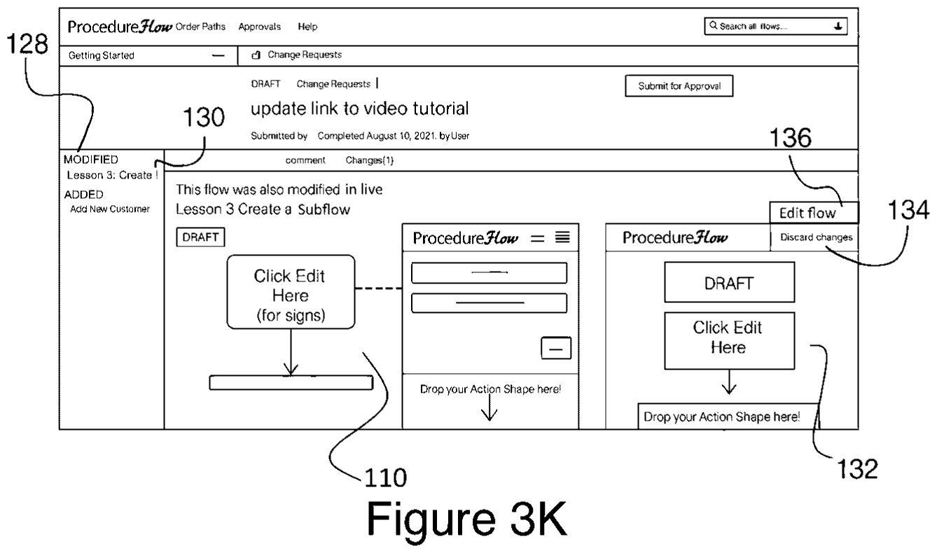

Referring now to FIG. 3A, in order to create and/or edit flows a change request may be created or opened. Change requests may be accessed by moving the selector 42 from live to draft 44, which may cause a change-request engine to create, for an editing user, draft procedure-flow graphs as editable copies of all flows in a live version and to associate the draft procedure-flow graphs with a baseline identifier of the live procedure-flow graph. Movement of the selector 42 to draft 44 may also cause retrieval, from the data repository 18, of a list of open change requests associated with the editing user and with other users subject to role-based access controls.

A list of all open change requests each comprising a title 46 and a status 48 may be provided. The title 46 may be understood as a human-readable label indicative of an intended modification, for example “Add address validation branch” or “Update calibration sequence.” The status 48 may be understood as a workflow state designator reflecting progression of a change request through drafting and approval, for example “open-work in progress” or “open-pending approval.” Each list item may be selectable to open a corresponding change request, and access to a selected change request may be conditioned on role-based access controls that confirm requisite rights of an editing user.

A flow may be edited by selecting one of the open change request drafts, provided that the editing user has the requisite rights for accessing the change request, or a new change request may be initiated by selecting the New Change Request button 50. Activation of the New Change Request button 50 may prompt for the title 46 and for an entry point that defines included flows 28, may create draft procedure-flow graphs for the included flows 28 as editable copies of corresponding live procedure-flow graphs, and may associate the created drafts with a baseline identifier and with a newly created change-request record stored in the data repository 18.

The open change requests may be filtered by assignee 52 and by current state 54. The assignee 52 may be understood as a designated editing user responsible for making edits within a change request; example filter values may include anyone, unassigned, or assigned to the editing user. The current state 54 may be understood as a selectable subset of workflow states usable to constrain the displayed list; example filter values may include open-work in progress (edits ongoing and not submitted), open-declined (approval declined and edits not yet revised), open-changes requested (returned by an approver with requested modifications), open-pending approval (submitted and awaiting approver action), published (approved and published to replace the live procedure-flow graph), or all.

Additionally, an option may be provided for annotating an open change request with comments or suggestions. A comment may be understood as a free-form textual annotation stored as metadata associated with a change-request record, for example “Revise label on Decision node D-17” or “Confirm data field units,” and a suggestion may be understood as a proposed modification expressed without directly applying an edit, for example “Consider adding a validation step before submission.” Comments and suggestions may be persisted in the data repository 18 with author identifiers and timestamps and may be rendered within a discussion or activity view associated with a selected change request, with creation and viewing subject to role-based access controls.

Referring now to FIG. 3B in addition to FIG. 3A, upon creating a new open change request 46 by selecting the New Change Request button 50 or opening an existing open change request, a draft 44 of a flow may be displayed within the procedure flow viewer 26 on a client device 22, and, for an editing user, a side-by-side view of a live procedure-flow graph and the draft 44 may be rendered with visual highlighting of graph-node-level and graph-edge-level edits. To create a new flow, an editing user, using a web browser of a client device 22, may navigate within the procedure flow viewer 26 to a location where the new flow will start, navigation being understood as moving a viewport to a designated entry location within a canvas that will contain symbolized steps and connecting flow arrows 40. To edit an existing flow, an editing user, using a web browser of a client device 22, may navigate to the flow to be edited and may select the Edit flow button 56 to enter an editing mode in which edits are represented as operations selected from add-node, remove-node, modify-node-attribute, add-edge, remove-edge, and retarget-edge and are applied to the draft 44.

Still referring now to FIG. 3B, creation of new flows or editing of existing flows may be performed within the procedure flow viewer 26, where edits may be represented as operations selected from add-node, remove-node, modify-node-attribute, add-edge, remove-edge, and retarget-edge and may be applied to a draft procedure-flow graph associated with a change request.

Selection of the Flows tab 58 may activate a draft navigation mode on a client device 22 that executes traversal across flows 28 via flow arrows 40, including evaluation of branches originating from Decision steps 34, to validate link integrity and expected branching behavior prior to approval.

Referring to FIG. 3C in addition to FIG. 3B, modifications may be viewed by selecting the Changes tab 60, which may render a side-by-side view displaying the live flow 62 as a live procedure-flow graph and the edited flow 64 as a draft procedure-flow graph with visual highlighting of graph-node-level and graph-edge-level edits. Within the Changes tab 60, a changes panel may be presented that lists edits by operation type and affected node identifiers, each listed edit being navigable to a synchronized visualization region within the live flow 62 and the edited flow 64.

Modifications may be discarded by selecting Discard change 66 from the View flow menu 68, where invocation of Discard change 66 may remove selected edits from the draft procedure-flow graph. When a portion corresponding to a defined flow within a multi-flow change request is targeted, selection of Discard change 66 from the View flow menu 68 may effect a flow-scoped discard that discards edits to the selected flow while retaining other edits to one or more other flows.

Referring back to FIG. 3A, when the selector 42 is set to draft 44, a list of change requests may be provided. If a role of a user is Viewer, then only Approved change requests may be displayed and the assignee filter 52 and the state filter 54 may be unavailable. Approved change requests may be understood as change requests in a published state that have been approved and that replaced a corresponding live procedure-flow graph. For users whose role is Contributor or higher, the list may default to all open change request drafts that are assigned to anyone to edit. Assigned to anyone may be understood as a filter condition that applies no assignee constraint and therefore includes unassigned change requests and change requests assigned to any editing user. Setting the assignee filter 52 to Assignee may display only change requests assigned to the current user or unassigned. Assignee within the assignee filter 52 may be understood as a filter value that restricts results to change requests where the designated assignee corresponds to the current user or where no assignee has yet been designated. Similarly, setting the state filter 54 to a given state value may limit displayed change requests to change request drafts in that specific state. A state value may be understood as a workflow state designator, for example open—work in progress, open—pending approval, or published.

Referring now to FIG. 3D in addition to FIG. 3A, change requests 46 may be viewed by clicking on the title 46 of the change request which displays the change request page 70. Three tabs are displayed with the change request: the Flows tab 58, the Changes tab 60, and a discussion view presented as a tab that renders comments and suggestions associated with the change request. The Flows tab 58 may render a procedure flow within the procedure flow viewer 26 for the change request, may enable navigation across flows 28 and flow arrows 40 in a draft navigation mode, and may expose editing controls including an Edit flow button 56 and a View flow menu 68 wherein Discard change 66 may be invoked to remove edits from a selected flow within a multi-flow change request. The Changes tab 60 may render a side-by-side view of a live procedure-flow graph 62 and an edited flow 64 as a draft procedure-flow graph with visual highlighting of graph-node-level and graph-edge-level edits, and may present a changes panel listing edits by operation type and affected node identifiers, each listed edit being navigable to a synchronized visualization region. The discussion view presented as a tab may render comments and suggestions persisted in the data repository 18 with author identifiers and timestamps, creation and viewing of comments and suggestions being subject to role-based access controls. The change request page 70 may further display metadata including the title 46, the status 48, an assignee 52, and a current state 54, and may expose actions conditioned on role-based access controls including assignment of the change request, submission for approval to an approval module, approval and publishing of an approved draft, and invocation of a “merge from live” control to trigger a rebase operation.

Overview 72 may be presented within the change request page 70 and may display information about an overall change request, including conflict alerts and a history of changes to the change request. A conflict alert may be understood as a notification generated upon detection of a conflict under the predetermined conflict rules or detection of a baseline mismatch where a baseline identifier of a draft procedure-flow graph differs from a current identifier of a live procedure-flow graph and where a rebase operation is required or has been performed. The history of changes may include at least status 48 transitions, assignee 52 assignments, and comments and suggestions associated with the change request, each persisted in the data repository 18 with author identifiers and timestamps. The history of changes may further include current state 54 updates, submission for approval, approval and publishing of an approved draft by an approval module, and receipt of out-of-date notifications for drafts associated with prior baseline identifiers. Overview 72 may render a baseline provenance record for a draft associated with the change request including a baseline identifier, a creation timestamp, and a list of merged live updates applied via rebase. The provenance record enables deterministic reapplication of edits during subsequent rebases and supports efficient computation of changes without reprocessing unaffected subgraphs. Content rendered within Overview 72 may be conditioned on role-based access controls such that contributors and approvers may view editing and approval activity while viewers may view information limited to published drafts.

Flows 74—displays a copy of all existing flows in the entry point allowing the editing user to navigate the flows and make edits. The copy may be rendered within the procedure flow viewer 26 on a client device 22 as draft procedure-flow graphs corresponding to flows 28 included in the entry point, each draft procedure-flow graph being an editable copy associated with a baseline identifier of a live procedure-flow graph stored in the data repository 18. Navigation may include traversal across flow arrows 40 between symbolized steps including Action steps 30, Decision steps 34, Data steps 36, and Backstories 38, and activation of a draft navigation mode to evaluate branching from Decision steps 34. Editing may be performed using controls including an Edit flow button 56 and a View flow menu 68, and edits may be represented as operations selected from add-node, remove-node, modify-node-attribute, add-edge, remove-edge, and retarget-edge applied to the draft 44. Selection of Discard change 66 from the View flow menu 68 may effect a flow-scoped discard that removes edits to a selected flow while retaining edits to other flows within a multi-flow change request. Applied edits may be persisted in the data repository 18 as part of the draft procedure-flow graphs and may be surfaced within a Changes tab 60 as a side-by-side visualization relative to a live procedure-flow graph 62 and an edited flow 64.

Changes 76—may display a side-by-side view comprising a live procedure-flow graph 62 as captured at a baseline identifier associated with a change request and an edited flow 64 as a draft procedure-flow graph, with visual highlighting of graph-node-level and graph-edge-level edits. The side-by-side view may be synchronized such that selection of an item in a changes panel navigates both the live procedure-flow graph 62 and the edited flow 64 to corresponding regions. The changes panel may list edits by operation type selected from add-node, remove-node, modify-node-attribute, add-edge, remove-edge, and retarget-edge and by affected node identifiers, each listed edit being navigable to a synchronized visualization region. Where a baseline mismatch is detected between a baseline identifier of a draft procedure-flow graph and a current identifier of a live procedure-flow graph, a conflict alert may be surfaced within Changes 76 and a “merge from live” control may be exposed to trigger a rebase operation by a graph engine that aligns corresponding graph nodes and graph edges and replays non-conflicting edits. During or after the rebase operation, conflicts detected under predetermined conflict rules including concurrent edits to a same node attribute, deletion-versus-modification of a same node or edge, or divergent retargeting of a shared edge endpoint may be highlighted within the side-by-side view. Resolution actions supported by a conflict-resolution engine may be initiated from Changes 76, including flow-scoped discard that discards edits to a selected flow within a multi-flow change request while retaining other edits and a placeholder-copy workflow that copies local conflicting edits into a temporary placeholder graph, discards a conflicted portion, reinitializes the portion from the current live procedure-flow graph, and reapplies the copied edits to surface residual conflicts. Role-based access controls may condition availability of side-by-side visualization, rebase initiation, and resolution actions within Changes 76, with viewers being limited to viewing published drafts.

Still referring to FIG. 3D, a list 78 of the various edits applied to the change request is provided, along with an identification of the flows edited 80 and the user 82 who carried out the edit. The list 78 may be rendered as a changes panel that lists edits by operation type selected from add-node, remove-node, modify-node-attribute, add-edge, remove-edge, and retarget-edge and by affected node identifiers, each listed edit being navigable to a synchronized visualization region within a side-by-side view of a live procedure-flow graph and a draft procedure-flow graph. The flows edited 80 may identify flows 28 within an entry point associated with the change request and may be recorded for each edit item together with persistent identifiers of affected graph nodes and graph edges to enable precise alignment within the procedure flow viewer 26. The user 82 may identify an authenticated editing user account associated with each edit under role-based access controls and may be displayed with a timestamp to indicate when the edit was applied to the draft procedure-flow graph stored in the data repository 18. Items in the list 78 may indicate validation status resulting from a rebase operation and may visually flag conflicts detected under predetermined conflict rules including concurrent edits to a same node attribute, deletion-versus-modification of a same node or edge, or divergent retargeting of a shared edge endpoint. Selection of an item in the list 78 may focus the procedure flow viewer 26 on a corresponding subgraph and may surface an option to perform resolution actions including flow-scoped discard for a selected flow within a multi-flow change request or initiation of a placeholder-copy workflow via a conflict-resolution engine. By way of example, the list 78 may include an entry “modify-node-attribute on node ID N-214 in Main Intake Flow” under the flows edited 80 with the user 82 identified as an assigned contributor, and an entry “add-edge from N-214 to N-307 in Review Flow” with the user 82 identified as an approver who reassigned the change request and applied an edit.

Referring now to FIG. 3E in addition to FIG. 3D, upon selection of the Overview tab 72, users with sufficient rights, for example a user with the role Contributor or higher, may annotate comments to a selected change request 46 via a comments field 86 to confirm what changes are being made, offer suggestions, and provide related notes. The comments field 86 may be understood as an input control that captures free-form textual content associated with the selected change request 46. A comment may be understood as a free-form textual annotation stored as metadata associated with the selected change request 46, for example “Confirm retarget-edge on node N-214” or “Summarize all modify-node-attribute edits in Review Flow.” A suggestion may be understood as a proposed modification expressed without directly applying an edit, for example “Add Data step before submission” or “Relabel Decision outcomes for clarity.”

Users with lesser rights, such as a user with the role Viewer, may annotate comments to a published change request, creation of such comments being subject to role-based access controls and being limited to change requests that are in a published state.

Comments may be notified to the assignee and to users who previously made edits or commented on the selected change request 46, and comments may be included in a change request history rendered within the Overview tab 72. Notification of comments may be understood as transmission of an event to client devices 22 associated with the assignee and the previously engaged users, the event indicating availability of a newly added comment. Submission of a comment may be performed by selecting the comment button 88, where activation of the comment button 88 may cause the comment to be persisted in the data repository 18 with an author identifier and a timestamp, appended to the change request history within the Overview tab 72, and queued for notification delivery to the assignee and the previously engaged users.

Referring to FIG. 3F, users with the requisite level of rights such as an approver may assign a change request 46 to a different user or to the approving user to take over edits. Assignment may be performed by opening the change request 46 within a change request page 70, choosing Edit change request 90 from available menu options, selecting an assignee from assignees who are members of the same entry point under role-based access controls, and selecting an update change request control (not shown). Activation of the update change request control may cause the change request 46 to be re-associated in the data repository 18 with a designated editing user account while retaining a draft procedure-flow graph and a baseline identifier associated with the change request 46. Role-based access controls may enforce that only users having an approver role are enabled to perform assignment actions, may revoke editing access for a previously assigned editing user, and may grant editing access for a newly assigned editing user. A newly assigned editing user may, using a client device 22, render a side-by-side view of a live procedure-flow graph and a draft procedure-flow graph with visual highlighting of graph-node-level and graph-edge-level edits, perform edits represented as operations selected from add-node, remove-node, modify-node-attribute, add-edge, remove-edge, and retarget-edge, and submit the draft for approval using an approval module.

Still referring to FIG. 3F, once all desired changes have been made in the change request 46, the change request may be submitted for approval by selecting Submit for Approval 92 within a change request page 70, where selection of Submit for Approval 92 may cause a client device 22 to transmit a submission instruction to an approval module of the server portion 12. In response to the submission instruction, the approval module may register a draft procedure-flow graph associated with the change request 46 as submitted, update a status 48 to open-pending approval, and append a status 48 transition entry to an Overview 72 history of changes with an author identifier and a timestamp in accordance with role-based access controls. A confirmation bar (not shown) may be rendered by the procedure flow viewer 26 to confirm that the draft has been submitted for approval.

Modifications to a flow 28 may not be reflected in a live version until approved and published, approval being performed by a user having an approver role in accordance with role-based access controls and publication being performed by the approval module. Upon publication, the approval module may publish an approved draft by replacing the live procedure-flow graph in the data repository 18 and may flag other drafts associated with a prior baseline identifier as out-of-date, and out-of-date notifications may be transmitted to client devices 22 holding drafts with mismatched baselines with a “merge from live” control being provided to trigger a rebase operation. Viewers under role-based access controls may remain limited to viewing only published drafts until publication has occurred.

Referring now to FIG. 3G, following submission of a change request 46 for approval, a client device 22 associated with an approving user may render controls enabling selection of Approve and Publish 94 or Cancel Approval 96, the controls being surfaced by an approval module under role-based access controls.

Selection of Approve and Publish 94 may cause the approval module to publish an approved draft by replacing a live procedure-flow graph in the data repository 18, to flag other drafts associated with a prior baseline identifier as out-of-date, and to transmit out-of-date notifications to client devices 22 holding drafts with mismatched baselines together with a “merge from live” control to trigger a rebase operation. Selection of Approve and Publish 94 may further update a status 48 to published and may append a corresponding entry to an Overview 72 history of changes with an author identifier and a timestamp.

Selection of Cancel Approval 96 may cancel an approval action for the change request 46, may maintain the draft in a non-published state, and may update the status 48 to a non-approved workflow state such as open—changes requested or open—declined, with a corresponding entry appended to the Overview 72 history of changes with an author identifier and a timestamp.

Users designated as approvers and administrators may self-approve a change request 46 associated with the same user by selecting Approve and Publish 94 without having to switch to the approvals tab, availability of Approve and Publish 94 being conditioned on role-based access controls. Users designated as contributors are unable to self-approve change requests and are required to submit change requests to a user designated as an approver or administrator, and, for users designated as contributors, Approve and Publish 94 may be disabled or not rendered.

Still referring to FIG. 3G, selection of Approve and Publish 94 may cause an approval module to publish an approved draft by replacing a live procedure-flow graph in the data repository 18, whereupon the published flow 28 may subsequently be rendered to all users as the current live version within the procedure flow viewer 26. Availability of Approve and Publish 94 may be conditioned on role-based access controls. Publication may further flag other drafts associated with a prior baseline identifier as out-of-date and may trigger out-of-date notifications to client devices 22 holding drafts with mismatched baselines together with a “merge from live” control to initiate a rebase operation, and a status 48 may be updated to published with a corresponding entry appended to an Overview 72 history of changes including an author identifier and a timestamp.

Still referring to FIG. 3G, users designated as approvers or administrators under role-based access controls may be responsible for reviewing suggested changes and for either approving, declining, or requesting changes, where approving may be understood as authorizing publication of a draft procedure-flow graph, declining may be understood as rejecting a draft and setting a workflow state to a non-approved state such as open—declined, and requesting changes may be understood as returning a draft to an editing state such as open—changes requested with associated feedback. In order to view change requests 46 submitted for approval, an approving or administrating user may select the Approvals tab 98, whereupon a list of change requests 46 pending approval may be presented from which a given change request 46 pending approval may be selected, pending approval being understood as a workflow state such as open pending approval. Upon selection of a change request 46 from the pending approval list, selection of the Overview tab 100 of the change request may list the history 102 of changes made, the history 102 being understood as a chronological record that may include at least submission events, status transitions, assignee updates, and comments or suggestions with author identifiers and timestamps.

Referring to FIG. 3H in addition to FIG. 3G, changes may be reviewed by selecting the Changes tab 104, which may render a side-by-side view with synchronized regions and visual highlighting of graph-node-level and graph-edge-level edits. A list 106 of modifications including additions and deletions and other modifications made within the change set may be provided, the change set being understood as the collection of edits represented as operations selected from add-node and add-edge for additions, remove-node and remove-edge for deletions, and modify-node-attribute and retarget-edge for other modifications, each operation being associated with affected persistent identifiers of graph nodes and graph edges. Selecting a modification 108 from the list 106 may navigate a synchronized visualization region and may provide a side-by-side comparison of the current (old) live version 110 and a draft (new) version comprising the suggested changes 112, where the current (old) live version 110 may be understood as a live procedure-flow graph as captured at a baseline identifier associated with the change request and the draft (new) version 112 may be understood as a draft procedure-flow graph containing the proposed edits. Differences between the current (old) live version 110 and the draft (new) version 112 may be highlighted at graph-node-level and graph-edge-level granularity, and items in the list 106 may expose operation type, affected node identifiers, and flow context to enable precise alignment within the side-by-side view. Where a baseline mismatch is detected between a baseline identifier of the draft (new) version 112 and a current identifier of a live procedure-flow graph, a conflict alert may be surfaced within the Changes tab 104 and a “merge from live” control may be exposed to trigger a rebase operation that aligns corresponding elements and replays non-conflicting edits. Conflicts detected under predetermined conflict rules including concurrent edits to a same node attribute, deletion-versus-modification of a same node or edge, or divergent retargeting of a shared edge endpoint may be visually indicated within the side-by-side comparison, and resolution actions may be initiated including flow-scoped discard limited to a selected flow within a multi-flow change request and a placeholder-copy workflow that temporarily preserves local edits, resets a conflicted portion from the live procedure-flow graph, and reapplies the preserved edits. Availability of the Changes tab 104, the list 106, the modification 108 selection, and rebase or resolution actions may be conditioned on role-based access controls.

By selecting the Flows tab 114 the navigation of all flows and links may be tested to see how the modified version will function when live, where activation of the Flows tab 114 may initiate a draft navigation mode on a client device 22 that executes traversal across flows 28 via flow arrows 40, evaluates branching originating from Decision steps 34, and validates link integrity and expected branching behavior, optionally enforcing completion of critical Action steps 32 before allowing traversal along designated downstream connections.

Still referring to FIG. 3G and FIG. 3H, approval of changes may be performed by selecting the Overview tab 100 and then selecting Approve and Publish 94 within a change request page 70, availability of Approve and Publish 94 being conditioned on role-based access controls. Selection of Approve and Publish 94 may cause an approval module to publish an approved draft by replacing the live procedure-flow graph in the data repository 18, to update a status 48 to published, and to append a corresponding entry to an Overview 72 history of changes with an author identifier and a timestamp; other drafts associated with a prior baseline identifier may be flagged as out-of-date and out-of-date notifications may be transmitted to client devices 22 together with a “merge from live” control to trigger a rebase operation. If approval and publication are not desired, a request-changes action may be invoked to return a change request to an editing state such as open—changes requested and to capture reasons, suggested modifications, and related notes, the captured information being persisted as comments and suggestions within the Overview tab 100, for example a reason “Revise label on Decision node D-17” or a suggestion “Add Data step before submission.” Reassignment of the change request may be performed by changing the assignee 116, assignment being initiated via Edit change request 90 and being enforced under role-based access controls such that only users having an approver role are enabled to update a designated editing user, whereupon editing access for a previously assigned editing user may be revoked and editing access for a newly assigned editing user may be granted. Alternatively, an approval action may be declined by selecting Cancel Approval 118, which may maintain a draft in a non-published state and may update the status 48 to a non-approved workflow state such as open—declined with a corresponding entry appended to the Overview 72 history of changes including an author identifier and a timestamp.

Referring now to FIG. 3I, when a change request 46 is opened, an out-of-date message 120 may be rendered upon detection of a baseline mismatch where a baseline identifier associated with a draft procedure-flow graph differs from a current identifier of a live procedure-flow graph. Such a baseline mismatch may occur when changes in another change request are approved and published after creation of the change request 46, thereby causing the current live version to diverge from the live version on which the draft procedure-flow graph was based. To manage this condition, selection of Merge new changes from live 122 may be provided to merge the current live version into the draft associated with the change request 46. Selection of Merge new changes from live 122 may invoke a graph engine to perform a rebase operation that aligns graph nodes and graph edges of the draft procedure-flow graph to corresponding graph nodes and graph edges of the current live procedure-flow graph, replays non-conflicting edits from the draft, and preserves the edits in a rebased draft while maintaining topological ordering and validating that mandatory navigation links remain connected, a conflict being raised when a validation check fails. Validation includes reachability analysis from designated roots to mandatory targets; failures are surfaced as conflicts requiring resolution. As in FIG. 3H, a list of affected flows may be rendered on the left, and a side-by-side display may present an old live version understood as the live procedure-flow graph as captured at the baseline identifier associated with the change request alongside the current live version, with visual highlighting of graph-node-level and graph-edge-level differences. The side-by-side display may enable review of the differences and confirmation of incorporation of non-conflicting updates into the change request 46. During or after the rebase operation, conflicts may be detected under predetermined conflict rules including at least concurrent edits to a same node attribute, deletion of a node or an edge in one graph while modified in the other, or reassignment of an edge endpoint altered by both graphs, with conflicts being highlighted within the side-by-side display. Resolution actions supported by a conflict-resolution engine may be initiated from the side-by-side display, including flow-scoped discard that discards edits to a selected flow within a multi-flow change request while retaining other edits, and a placeholder-copy workflow that copies local conflicting edits into a temporary placeholder graph, discards a conflicted portion from the draft, reinitializes the portion from the current live procedure-flow graph, and reapplies the copied edits to surface residual conflicts.

Referring now to FIG. 3J, when a new live procedure-flow graph diverges from a draft associated with a change request 46 in a manner that violates predetermined conflict rules, a Conflict message 124 may be rendered and flagged to an authenticated user permitted to edit or approve under role-based access controls. The Conflict message 124 may be understood as a notification banner or dialog indicating that automatic merge semantics are undefined or non-deterministic, for example concurrent modification of a shared node attribute, deletion-versus-modification of a same node or edge, or divergent retargeting of a shared edge endpoint detected during difference computation or during a rebase operation. The Conflict message 124 may summarize affected flows 28 and identifiers of implicated graph nodes and graph edges and may expose a changes link 126 that deep-links to a conflict-focused review.

Selection of the changes link 126 within the Conflict message 124 may navigate the procedure flow viewer 26 to the Changes tab 104 with a filtered view scoped to conflicting items, where a side-by-side view comprising a live procedure-flow graph and a draft procedure-flow graph may be rendered with visual highlighting of graph-node-level and graph-edge-level conflicts. Within the Changes tab 104, a changes panel may list conflicting edits by operation type selected from add-node, remove-node, modify-node-attribute, add-edge, remove-edge, and retarget-edge and by affected persistent identifiers, each listed conflict being navigable to a synchronized visualization region. Resolution actions supported by a conflict-resolution engine may be initiated from the Changes tab 104, including a flow-scoped discard that discards edits to a selected flow within a multi-flow change request while retaining other edits and a placeholder-copy workflow that copies local conflicting edits into a temporary placeholder graph, discards a conflicted portion, reinitializes the portion from the current live procedure-flow graph, and reapplies the copied edits to surface residual conflicts. Availability of the changes link 126, the Changes tab 104, and the resolution actions may be conditioned on role-based access controls, with viewers being limited to read-only views of published drafts.

Referring now to FIG. 3K in addition to FIG. 3J, flow(s) that are in conflict 128 are listed on the left with a red exclamation mark 130, the red exclamation mark 130 being understood as a conflict indicator associated with a flow 28 that includes unresolved edits violating predetermined conflict rules, for example concurrent modification of a shared node attribute or deletion-versus-modification of a same graph element. Additionally, the live (old) version 110 is displayed side by side versus the conflicting version 132, the live (old) version 110 being understood as a current live procedure-flow graph and the conflicting version 132 being understood as a draft procedure-flow graph containing conflicting edits, with visual highlighting of graph-node-level and graph-edge-level differences. Selection of a listed flow in conflict 128 may navigate the side-by-side visualization to corresponding subgraphs aligned by persistent identifiers of affected graph nodes and graph edges. In order to resolve the conflict, when comparison indicates that the live (old) version 110 embodies the same edits as the draft, edits may be discarded by selecting Discard change 134, where selection of Discard change 134 effects a flow-scoped discard that removes edits to a selected flow within a multi-flow change request while retaining edits to one or more other flows in accordance with role-based access controls. Small differences may be addressed by performing the flow-scoped discard via Discard change 134 and initiating a new change request based on the current live (old) version 110. As an alternative to discarding, a placeholder-copy workflow may be invoked to copy local conflicting edits into a temporary placeholder graph, discard a conflicted portion, reinitialize the portion from the current live (old) version 110, and reapply the copied edits to surface residual conflicts within the side-by-side visualization.

Still referring to FIG. 3K, more extensive differences may be managed by selecting edit flow 136, which may initiate a placeholder-copy workflow wherein local edits associated with a flow in conflict are serialized into a patch artifact and copied into a temporary placeholder flow, after which the conflicted flow may be discarded. The conflicted portion may then be reinitialized from a current live procedure-flow graph, and the serialized edits are reapplied in a deterministic topological order onto the reinstated subgraph aligned by persistent identifiers and, when absent, by similarity heuristics based on at least step type, label text, and adjacency, while enforcing reachability and mandatory-link constraints; violations raise conflicts. Following successful reapplication and validation, the placeholder flow may be used to replace the portion originally in conflict. During reapplication, a topological ordering may be preserved and mandatory navigation links may be validated, a conflict being raised when a validation check fails. Selection of discard change 134 may discard edits only for a selected flow in conflict and not for an entire change request, and edits associated with other flows may remain intact. The evaluation may be repeated as required for each additional flow identified as in conflict.

The disclosed techniques improve the functioning of collaborative editing systems by automating graph alignment during rebase, accelerating conflict detection via computational diffs of node attributes and edges, preserving non-conflicting edits while preventing violations of mandatory navigation constraints, and reducing redundant computation and network traffic by limiting processing and updates to changed subgraphs. These improvements result from specific data structures and computer-implemented graph algorithms rather than from business-process logic. While the invention has been described with reference to illustrative embodiments, the foregoing description is not intended to be construed in a limiting sense. The phrase illustrative embodiments may be understood as non-limiting examples that elucidate elements, structure, and operations of the invention, for example a particular arrangement of components or a sequence of method steps. Various modifications or combinations of the illustrative embodiments of the invention will be apparent to persons skilled in the art upon reference to the foregoing description. The expression modifications or combinations may be understood as changes that retain the substance of the invention, for example substitution of functionally equivalent components, rearrangement or omission of steps, addition of optional features, or implementation of elements in hardware, software, or firmware. The term persons skilled in the art may be understood as practitioners having ordinary skill in the pertinent technical fields who, based on the foregoing description, may implement variations that achieve the same or substantially the same functions. Accordingly, the described invention is intended to encompass any such modifications or embodiments.

1. A collaborative procedure-flow editing system comprising:
a repository storing a live procedure-flow graph comprising nodes and directed edges, each node representing a step in a procedure and each edge representing a navigation link between steps;
a server comprising a processor and memory storing instructions that, when executed, implement:
(a) a change-request engine configured to create, for an editing user, a draft procedure-flow graph as an editable copy of the live procedure-flow graph and to associate the draft with a baseline identifier of the live procedure-flow graph, the draft procedure-flow graph comprising a plurality of graph nodes and a plurality of graph edges;
(b) a graph engine configured to:
(i) compute differences between the draft procedure-flow graph and the live procedure-flow graph;
(ii) detect a baseline mismatch when a baseline identifier of the draft procedure-flow graph differs from a current identifier of the live procedure-flow graph;
(iii) in response to the baseline mismatch, perform a rebase operation that:
aligns the graph nodes and the graph edges of the draft procedure-flow graph to corresponding graph nodes and graph edges of the current live procedure-flow graph; and
merges non-conflicting edits from the draft while retaining those edits in the rebased draft;
(iv) detect conflicts under predetermined conflict rules including at least one of: concurrent edits to a same node attribute, deletion of a node or edge in one graph while modified in the other, and reassignment of an edge endpoint altered by both graphs;
(c) a conflict-resolution engine configured to, upon detection of a conflict:
(i) present a side-by-side visualization of the current live procedure-flow graph and the conflicting draft procedure-flow graph with highlighted differences;
(ii) enable flow-scoped discard that discards edits to a portion of the draft without discarding other edits to one or more other portions; and
(iii) enable a placeholder-copy workflow that:
copies local conflicting edits into a temporary placeholder graph,
discards the conflicting portion of the graph, and
reapplies the discarded edits from the placeholder graph onto a corresponding subgraph of the current live procedure-flow graph;
(d) an approval module configured to publish an approved draft by replacing the live procedure-flow graph in the repository and to flag other drafts associated with a prior baseline identifier as out-of-date; and
one or more client devices each configured to:
(i) render, for an editing user, a side-by-side view of the live procedure-flow graph and the draft procedure-flow graph with visual highlighting of graph-node-level and graph-edge-level edits; and
(ii) receive user inputs to initiate the rebase operation, resolve conflicts using the flow-scoped discard and placeholder-copy workflows, and submit the draft for approval.

2. The system of claim 1, wherein each of the plurality of graph nodes includes a persistent identifier and a step type selected from Action, Decision, Data, and Backstory, and wherein the graph engine aligns graph nodes using the persistent identifier and, when absent, using a similarity heuristic based on at least the step type, label text, and adjacency.

3. The system of claim 2, wherein the similarity heuristic comprises at least one of: hashing node content, attribute-vector comparison, and neighborhood overlap scoring.

4. The system of claim 1, wherein the graph engine represents edits as operations selected from: add-node, remove-node, modify-node-attribute, add-edge, remove-edge, and retarget-edge, and merges the operations against the current live procedure-flow graph during the rebase operation.

5. The system of claim 1, wherein the rebase operation preserves a topological ordering and validates that mandatory navigation links remain connected post-merge, raising a conflict when a validation check fails.

6. The system of claim 1, wherein the predetermined conflict rules are applied deterministically such that identical inputs produce identical merged graphs and conflict sets.

7. The system of claim 1, wherein the conflict-resolution engine supports iterative resolution across multiple conflicting subgraphs, persisting resolved portions while other conflicts remain outstanding.

8. The system of claim 1, wherein the client devices provide a changes panel listing edits by operation type and affected node identifiers, each item navigable to a synchronized side-by-side visualization region.

9. The system of claim 1, wherein the approval module, upon publishing an approved draft, transmits out-of-date notifications to client devices holding drafts with mismatched baselines and provides a one-click “merge from live” control to trigger the rebase operation.

10. The system of claim 9, wherein the notifications comprise serialized deltas of node-and edge-level changes that update local baselines without transmitting full graph states.

11. The system of claim 1, wherein, when performing the flow-scoped discard, only edits to a selected flow within a multi-flow change request are discarded, leaving edits to other flows intact.

12. The system of claim 1, wherein the placeholder-copy workflow serializes local edits into a patch artifact, discards the conflicted portion from the draft, reinitializes the portion from the current live procedure-flow graph, and reapplies the patch artifact, thereby surfacing any residual conflicts.

13. The system of claim 1, further comprising role-based access controls wherein contributors can create and edit drafts but cannot approve, approvers can approve and publish, and viewers can view only published drafts, and wherein side-by-side visualization and rebase controls are disabled for viewers.

14. The system of claim 1, wherein the client devices provide a draft navigation mode that executes navigation across the draft procedure-flow graph to validate link integrity and expected branching behavior prior to approval.

15. The system of claim 1, wherein the graph engine maintains a baseline provenance record for each draft including the baseline identifier, creation timestamp, and a list of merged live updates applied via rebase.

16. The system of claim 15, wherein the baseline provenance record further includes a parent commit identifier and a rebase lineage.

17. A computer-implemented method for collaborative editing of a procedure-flow graph, comprising:
storing, in a repository, a live procedure-flow graph comprising graph nodes and graph edges;
creating, for an editing user, a draft procedure-flow graph as a copy of the live procedure-flow graph and associating the draft with a baseline identifier of the live procedure-flow graph;
rendering, on a client device, a side-by-side view of the live procedure-flow graph and the draft procedure-flow graph with highlighted edits;
detecting that the baseline identifier of the draft does not match a current identifier of the live procedure-flow graph;
in response, performing a rebase operation comprising aligning corresponding graph nodes and corresponding graph edges of the draft procedure-flow graph to the graph nodes and the graph edges of the current live procedure-flow graph and merging non-conflicting edits from the draft into a rebased draft while retaining the edits;
detecting conflicts based on predetermined conflict rules including at least concurrent modification of a same node attribute and deletion-versus-modification of a same graph node or a same graph edge;
presenting a conflict-resolution interface including:
(i) flow-scoped discard of edits; and
(ii) a placeholder-copy workflow that copies local edits into a temporary placeholder, discards a conflicting portion of the draft procedure-flow graph, initializes a subgraph from the current live procedure-flow graph, and reapplies the local edits from the placeholder thereto; and
publishing, upon approval, the draft procedure-flow graph as the live procedure-flow graph and flagging other drafts with mismatched baselines as out-of-date.

18. The method of claim 17, wherein aligning nodes employs persistent node identifiers and, absent such identifiers, employs a similarity heuristic using step type, label text, and neighboring topology.

19. The method of claim 17, further comprising validating the rebased draft for link integrity and mandatory-step connectivity and, upon validation failure, surfacing a conflict requiring user action.

20. The method of claim 17, further comprising listing edit operations in a changes panel and, upon selection of an item, focusing the side-by-side view on the affected subgraph.

21. The method of claim 17, wherein publishing triggers notifications to client devices maintaining drafts with mismatched baselines and provides a user-selectable control to initiate the rebase operation.

22. The method of claim 17, further comprising recording, for each draft, a baseline provenance including at least the baseline identifier and a log of applied rebases.

23. The method of claim 17, wherein, when performing the flow-scoped discard, only edits to a selected flow within a multi-flow change request are discarded, preserving other edits in the change request.

24. The method of claim 17, further comprising enforcing role-based permissions defining contributor, approver, and viewer roles with corresponding capabilities.

25. (canceled)
